(19) United States
(12) Patent Application Publication
(10) Pub. No.: US 2025/0346070 A1
(43) Pub. Date: Nov. 13, 2025

(54) WHEEL

(71) Applicants: HYUNDAI MOTOR COMPANY, Seoul (KR); KIA CORPORATION, Seoul (KR)

(72) Inventor: Jae Hong Jung, Hwaseong-si (KR)

(73) Assignees: HYUNDAI MOTOR COMPANY, Seoul (KR); KIA CORPORATION, Seoul (KR)

(21) Appl. No.: 18/914,884

(22) Filed: Oct. 14, 2024

(30) Foreign Application Priority Data
May 7, 2024 (KR) 10-2024-0059946

(51) Int. Cl. B60B 19/12; B60B 19/00

(52) U.S. Cl. CPC B60B 19/12; B60B 19/003

(57) ABSTRACT

A wheel includes a rim part provided to be rotatable about a rotation axis X of the wheel. The wheel includes: a plurality of first roller members provided in a direction in which the plurality of first roller members surrounds the rotation axis X, and a plurality of second roller members spaced apart from the plurality of first roller members in a direction in which the rotation axis X extends. The plurality of second roller members is provided in a direction in which the plurality of second roller members surrounds the rotation axis X. In particular, the first roller members and the second roller members are alternately disposed in a circumferential direction A of the wheel.

### CROSS-REFERENCE TO RELATED APPLICATION

This application claims priority to and the benefit of Korean Patent Application No. 10-2024-0059946, filed in the Korean Intellectual Property Office on May 7, 2024, the entire contents of which are incorporated herein by reference.

### TECHNICAL FIELD

The present disclosure relates to a wheel capable of being applied to a movable body such as a vehicle.

### BACKGROUND ART

A mecanum wheel refers to a wheel that has a plurality of rollers obliquely and rotatably provided on an outer portion of a rim, such that the wheel may move not only in a forward/rearward direction of the wheel, but also in various directions such as a leftward/rightward direction and a diagonal direction of the wheel. In particular, the mecanum wheel is advantageous because the mecanum wheel may move in various directions only by rotating the rim by using a drive part, such as a motor, without separately steering the wheel.

Because the mecanum wheel is also a kind of wheel, the mecanum wheel generally has a circular or cylindrical shape as a whole. However, in the related art, because the plurality of rollers of the mecanum wheel is disposed in a circumferential direction of the wheel, uneven sections that deviate from the circular or cylindrical shape are formed between adjacent rollers among the plurality of rollers. In case that this section comes into contact with the ground surface, an impact may be applied to the wheel, and noise may occur, thereby causing a deterioration in ride quality of a movable body, such as a vehicle, to which the mecanum wheel is applied.

The statements in this section merely provide background information related to the present disclosure and may not constitute prior art.

### SUMMARY

The present disclosure has been made in an effort to improve ride quality of a movable body, to which a mecanum wheel is applied, by removing or reducing uneven sections formed between a plurality of rollers of the mecanum wheel.

In one aspect of the present disclosure, a wheel includes: a rim part configured to be rotatable about a rotation axis “X”, and a plurality of roller members rotatably coupled to the rim part and arranged to surround the rotation axis X. The wheel further includes a plurality of first roller members arranged to surround the rotation axis X; and a plurality of second roller members spaced apart from the plurality of first roller members in a direction in which the rotation axis X extends. The plurality of second roller members is arranged to surround the rotation axis X. In particular, the first roller members and the second roller members are alternately disposed in a circumferential direction “A” of the wheel.

An outer end of the rim part based on the direction in which the rotation axis X extends may be positioned to be closer to the inside based on the direction in which the rotation axis X extends than an outer end of the roller members based on the direction in which the rotation axis X extends.

A rotation center axis Y1 of the roller members with respect to the rim part may have a predetermined angle with respect to the rotation axis X.

The rotation center axis Y1 of the roller members may have an angle in a range of 40 degrees to 50 degrees with respect to the rotation axis X.

The rim part may include: a first side rim provided on a first side of the plurality of roller members based on an extension direction of the rotation axis X and configured such that a first side of the first roller members is rotatably coupled to the first side rim; a second side rim provided on a second other side of the plurality of roller members based on the extension direction of the rotation axis X and configured such that a first side of the second roller members is rotatably coupled to the second side rim; and a central rim provided between the first side rim and the second side rim based on the extension direction of the rotation axis X and configured such that a second side of the first roller members and a second side of the second roller members are rotatably coupled to the central rim. In another embodiment, the central rim may include: a central rim body configured to define a body of the central rim; a first central coupling region protruding from the central rim body and configured such that the second side of the first roller members is rotatably coupled to the first central coupling region; and a second central coupling region protruding from the central rim body and configured such that the second side of the second roller members is rotatably coupled to the second central coupling region.

The first central coupling region and the second central coupling region, which is provided adjacent to the first central coupling region, may be provided separately.

The first central coupling region and the second central coupling region, which is provided adjacent to the first central coupling region, may be at least partially spaced apart from each other in a direction in which a rotation center axis Y1 of the plurality of roller members extends relative to the rim part.

The first central coupling region and the second central coupling region, which is provided adjacent to the first central coupling region, may be at least partially spaced apart from each other in a direction intersecting a direction in which a rotation center axis Y1 of the plurality of roller members extends relative to the rim part.

Magnitudes of angles defined between rotation center axes Y1 of the plurality of roller members and the rotation axis X may correspond to one another.

The rotation center axes Y1 of the plurality of first roller members with respect to the rim part and the rotation center axes Y1 of the plurality of second roller members with respect to the rim part may be spaced apart from one another in a direction intersecting the direction in which the rotation center axis Y1 extends.

A curved surface region may be formed on the first roller member or the second roller member and formed at an outer end of the wheel based on the direction in which the rotation axis X extends, and the curved surface region may have a curved shape protruding outward.

The first roller member or the second roller member may include a section having a circular cross-section taken in a direction perpendicular to a rotation center axis Y1 of the roller member with respect to the rim part.

The first roller member or the second roller member may include a section in which a size of a cross-section taken in a direction perpendicular to a rotation center axis Y1 of the roller member with respect to the rim part decreases toward an outer end of the wheel based on the direction in which the rotation axis X extends.

When the first roller member and the second roller member are cut in a direction perpendicular to the direction in which the rotation axis X extends, outer peripheries of the first roller member and the second roller member based on a radial direction R of the wheel may each include a part of a circular shape having the rotation axis X as a center and a radius as a radius of the wheel.

The wheel may further include: a plurality of complementary members coupled to the rim part and provided in a direction in which the plurality of complementary members surrounds the rotation axis X, in which when the wheel is viewed from a position spaced apart from the wheel in the direction in which the rotation axis X extends, a non-uniformity section having a shape recessed inward in a radial direction R of the wheel is formed in the wheel, and in which the complementary member is provided to overlap the non-uniformity section.

The rim part may further include: a first side rim provided at one side of the plurality of roller members based on an extension direction of the rotation axis X and configured such that one side of the first roller members is rotatably coupled to the first side rim; and a second side rim provided at the other side of the plurality of roller members based on the extension direction of the rotation axis X and configured such that one side of the second roller members is rotatably coupled to the second side rim. The plurality of complementary members may be provided on at least one of the first side rim or the second side rim.

In another embodiment, the plurality of complementary members may be provided only on either the first side rim or the second side rim.

According to the present disclosure, the uneven sections formed between the plurality of rollers of the mecanum wheel, which has the structure in which the plurality of rollers is disposed, are removed or reduced, which may improve the ride quality of the movable body to which the mecanum wheel is applied.

### BRIEF DESCRIPTION OF THE DRAWINGS

FIG. 1 is a perspective view of a wheel according to a first embodiment of the present disclosure.

FIG. 2 is a front view of the wheel according to the first embodiment of the present disclosure.

FIG. 3 is a side view of the wheel according to the first embodiment of the present disclosure.

FIG. 4 is a perspective view of a wheel according to a second embodiment of the present disclosure.

FIG. 5 is a front view of the wheel according to the second embodiment of the present disclosure.

FIG. 6 is a side view of the wheel according to the second embodiment of the present disclosure.

FIG. 7 is a view schematically illustrating a state in which a rotation axis of the wheel and a rotation center axis of a roller member define a predetermined angle, and the rotation axis of the wheel and a rotation center axis of a complementary member define a predetermined angle in the wheel according to the first embodiment of the present disclosure.

FIG. 8 is a view illustrating shapes of the roller members when the wheel according to the first embodiment of the present disclosure is viewed from a position spaced apart from the wheel in a direction in which the rotation axis extends.

FIG. 9 is a perspective view of a wheel according to a third embodiment of the present disclosure.

FIG. 10 is a perspective view of the wheel according to the third embodiment of the present disclosure, i.e., a view illustrating a state in which some roller members are removed.

FIG. 11 is a front view of the wheel according to the third embodiment of the present disclosure.

FIG. 12 is a side view according to the third embodiment of the present disclosure.

FIG. 13 is a view schematically illustrating a state in which a rotation axis of the wheel and a rotation center axis of the roller member define a predetermined angle, and the rotation axis of the wheel and a rotation center axis of a complementary member define a predetermined angle in the wheel according to the third embodiment of the present disclosure.

FIG. 14 is a view illustrating shapes of the roller members when the wheel according to the third embodiment of the present disclosure is viewed from a position spaced apart from the wheel in a direction in which the rotation axis extends.

FIG. 15 is a perspective view of a wheel according to a fourth embodiment of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

When a component, device, element, or the like of the present disclosure is described as having a purpose or performing an operation, function, or the like, the component, device, or element should be considered herein as being “configured to” meet that purpose or to perform that operation or function.

In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

Hereinafter, a wheel according to the present disclosure is described with reference to the drawings.

The wheel according to the present disclosure may be mounted on a movable body (e.g., a vehicle) and configured to implement a movement of the movable body. In particular, the wheel according to the present disclosure may not only allow the movable body, which is equipped with the wheel according to the present disclosure, to move in a forward/rearward direction, but also allow the movable body to move in a leftward/rightward direction without steering the wheel, in a form similar to a so-called crab walk. The wheel according to the present disclosure may be a kind of mecanum wheel, i.e., a mecanum wheel having a novel shape different from that in the related art.

### Wheel

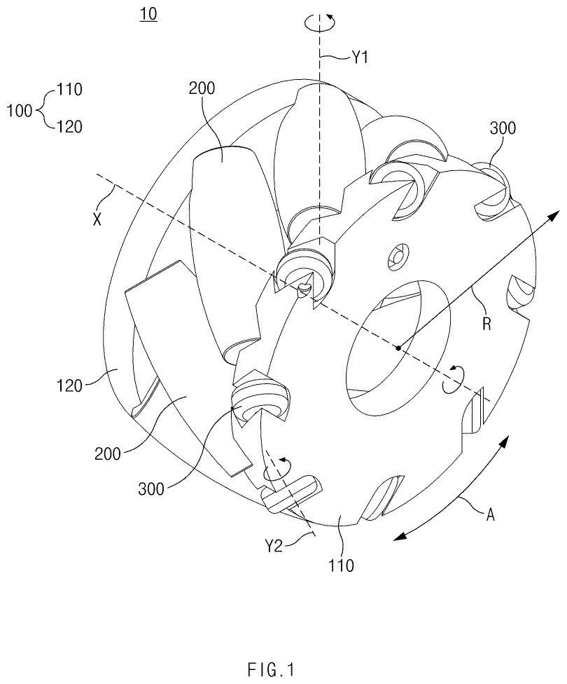

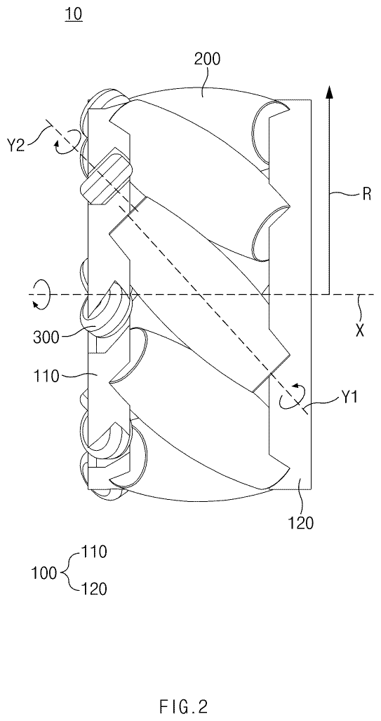

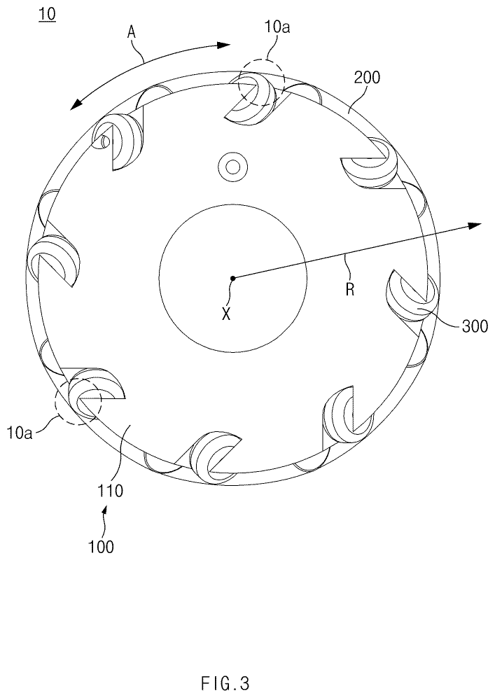

FIG. 1 is a perspective view of a wheel according to a first embodiment of the present disclosure, and FIG. 2 is a front view of the wheel according to the first embodiment of the present disclosure. FIG. 3 is a side view of the wheel according to the first embodiment of the present disclosure.

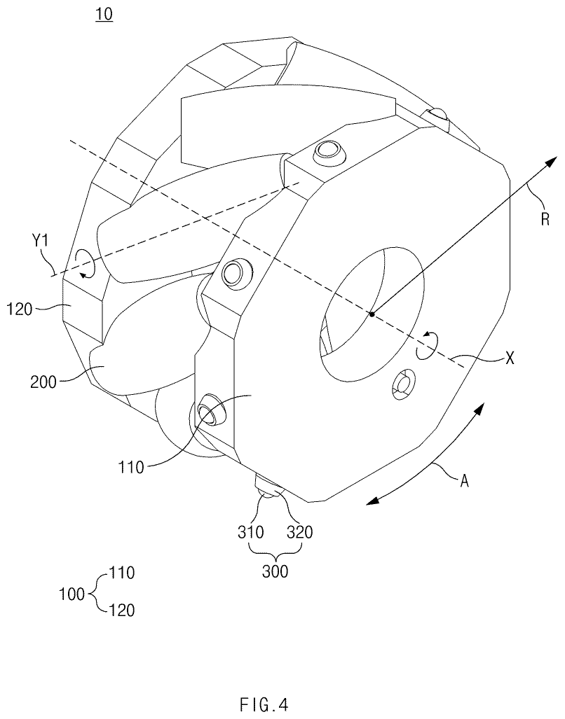

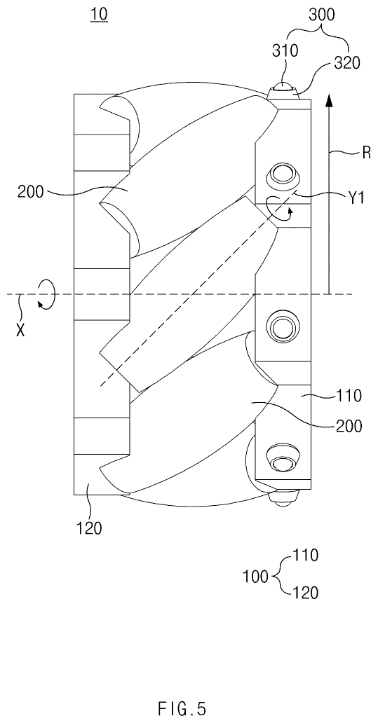

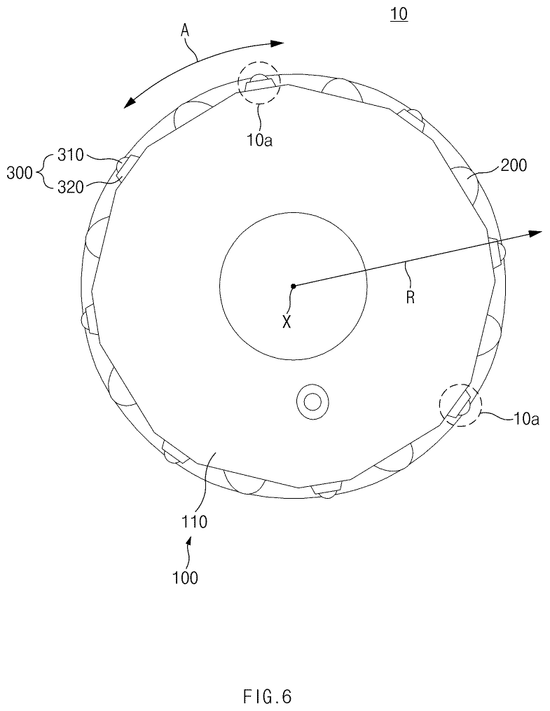

In addition, FIG. 4 is a perspective view of a wheel according to a second embodiment of the present disclosure, and FIG. 5 is a front view of the wheel according to the second embodiment of the present disclosure. FIG. 6 is a side view of the wheel according to the second embodiment of the present disclosure.

With reference to FIGS. 1 to 6, a wheel 10 according to the present disclosure may include a rim part 100 configured to be rotatable about a rotation axis X. More specifically, in case that the wheel 10 is mounted on a movable body (e.g., a vehicle), the wheel 10 may rotate about the rotation axis X. Hereinafter, in the present disclosure, the rotation axis X is referred to as a rotation axis of the wheel 10.

In one embodiment of the present disclosure, the wheel 10 may further include a plurality of roller members 200 rotatably coupled to the rim part 100 and provided in a direction in which the plurality of roller members 200 surrounds the rotation axis X. In other words, the roller members 200 are arranged to surround the rotation axis x, and may be rotatably coupled to an outer region of the rim part 100 in a radial direction R. The radial direction R extends perpendicularly to the rotation axis X. More specifically, the plurality of roller members 200 may be coupled to one side of the rim part 100 and configured to rotate in the state in which the plurality of roller members 200 is coupled to the rim part 100. Hereinafter, in the present specification, an axis of the rotation of the roller member 200, when the roller member 200 rotates, is referred to as a rotation center axis Y1 (“the first rotation center axis”) of the roller member 200.

According to the present disclosure, the rotation axis X of the wheel 10 and the first rotation center axis Y1 of the roller member 200 may define a predetermined angle without being parallel to each other. For example, the first rotation center axis Y1 of the roller member 200 may have an angle of 40 degrees or more and 50 degrees or less (i.e., in an angle range of 40 to 50 degrees) with respect to the rotation axis X of the wheel 10. Particularly, the first rotation center axis Y1 of the roller member 200 may have an angle of 45 degrees with respect to the rotation axis X of the wheel 10.

With reference to FIGS. 1 to 6, the wheel 10 according to the first embodiment of the present disclosure may further include a plurality of complementary members 300 coupled to the rim part 100 and disposed in a direction in which the plurality of complementary members 300 surrounds the rotation axis X. In other words, the complementary members 300 are arranged to surround the rotation axis X and may be rotatably coupled to the outer region of the rim part 100 in the radial direction R of the wheel 10.

According to the present disclosure, both the roller member 200 and the complementary member 300 may be coupled to the outer region in the radial direction R of the rim part 100. However, the roller member 200 and the complementary member 300 may perform different functions.

More specifically, the roller members 200 may be configured to define an overall outer surface of a peripheral region of the wheel 10 and define a region that mainly comes into contact with the ground surface while the wheel 10 travels on the ground surface. Therefore, the roller members 200 may be configured to support a load of the wheel 10 and a load of the movable body, such as a vehicle, equipped with the wheel. Therefore, the plurality of roller members 200 may define an overall shape of the peripheral region of the wheel 10.

According to the present disclosure, when the wheel 10 is viewed from a position spaced apart from the wheel 10 in a direction in which the rotation axis X extends, non-uniformity sections 10a may be formed on the peripheral surface of the wheel 10 defined by the plurality of roller members 200. In particular, the non-uniformity section 10a may have curvature properties different from curvature properties of another region adjacent to the non-uniformity section 10a in a circumferential direction A of the wheel 10. In this case, the configuration in which the non-uniformity section 10a and another region have different curvature properties may be understood as a configuration in which a curved shape of the non-uniformity section 10a is different from a curved shape of another region adjacent to the non-uniformity section 10a. For example, the non-uniformity section 10a may have a shape recessed inward in the radial direction R of the wheel 10 from another region adjacent to the non-uniformity section 10a in the circumferential direction A of the wheel 10. For example, when the wheel 10 is viewed from a position spaced apart from the wheel 10 in the direction in which the rotation axis X extends, the non-uniformity section 10a may be formed in a region in which the two adjacent roller members 200 overlap each other.

In case that a cross-section of the outer surface of the wheel 10 based on the radial direction R has an approximately circular shape, the non-uniformity section 10a may be a section spaced apart from the circular shape. In this case, the complementary member 300 according to the present disclosure may be provided to overlap the non-uniformity section and complement the non-uniformity section. Therefore, according to the present disclosure, because the complementary member 300 covers the non-uniformity section 10a formed in the outer surface of the wheel 10 based on the radial direction R, it is possible to reduce noise and impact that may be caused by the non-uniformity section 10a during a process in which the wheel 10 travels on the ground surface. Meanwhile, because the complementary member 300 is configured to geometrically complement the shape of the outer region of the peripheral region of the wheel 10 defined by the roller member 200, a size of the complementary member 300 may be smaller than a size of the roller member 200.

According to the first embodiment of the present disclosure, the rim part 100 may be divided into a plurality of regions. More specifically, with reference to FIGS. 1 to 6, the rim part 100 may include a first side rim 110 and a second side rim 120. The first side rim 110 is provided at one side of the roller member 200 based on the extension direction of the rotation axis X and configured such that one side of the roller member 200 is rotatably coupled to the first side rim 110. The second side rim 120 is provided at the other side of the roller member 200 based on the extension direction of the rotation axis X and configured such that the other side of the roller member 200 is rotatably coupled to the second side rim 120. In other words, the first side rim 110 and the second side rim 120 may define two opposite surfaces in the direction of the rotation axis X of the wheel 10.

In this case, according to the present disclosure, the complementary members 300 may be provided on one of or both the first side rim 110 and the second side rim 120. In one embodimenmt, the complementary members 300 may be provided on both the first side rim 110 and the second side rim 120. In another embodimenmt, the complementary members 300 may be provided only on either the first side rim 110 or the second side rim 120. For example, FIGS. 1 to 6 illustrate a state in which the complementary members 300 are provided only on the first side rim 110.

When the wheel 10 according to the present disclosure is mounted on the movable body such as a vehicle, the first side rim 110 may be positioned in an outer region of the movable body, and the second side rim 120 may be positioned in an inner region of the movable body. In this case, in case that the complementary members 300 are provided on the first side rim 110, the complementary members 300 of the first side rim 110, which is positioned in the outer region of the movable body, may come into contact with the ground surface or an obstacle on the ground surface when the movable body equipped with the wheel 10 moves in a direction (e.g., the leftward/rightward direction of the movable body) intersecting the rotation direction of the wheel. Therefore, the movable body may more smoothly move in the leftward/rightward direction in comparison with a case in which the complementary member 300 is not provided on the first side rim 110. For example, in case that the wheel 10 is provided in a left region of the movable body, the first side rim 110 may be positioned in an outer region of the left side of the movable body, such that when the movable body moves leftward, the complementary members 300 provided on the first side rim 110 may pass over the ground surface, which is positioned at the left side of the movable body, or an obstacle on the ground surface after coming into contact with the ground surface, which is positioned at the left side of the movable body, or the obstacle on the ground surface.

With reference to FIGS. 1 to 3, the complementary member 300 provided on the wheel 10 according to the first embodiment of the present disclosure may be rotatably coupled to the rim part 100. According to the first embodiment of the present disclosure, similar to the roller member 200, the complementary member 300 may rotate about a rotation center axis in the state in which the complementary member 300 is coupled to the rim part 100. Hereinafter, in the present disclosure, an axis of the rotation of the complementary member 300, when the complementary member 300 rotates, is referred to as a rotation center axis Y2 (i.e., “the second rotation center axis”) of the complementary member 300.

According to the first embodiment of the present disclosure, the second rotation center axis Y2 of the complementary member 300 with respect to the rim part 100 may have a predetermined angle with respect to the rotation axis X. More particularly, a magnitude of the angle defined between the first rotation center axis Y1 of the roller member 200 and the rotation axis X of the wheel 10 may be substantially equal or correspond to a magnitude of the angle defined between the second rotation center axis Y2 of the complementary member 300 and the rotation axis X of the wheel 10. Therefore, during the operating process of the wheel 10, the rotation direction of the roller member 200 and the rotation direction of the complementary member 300 are consistent with each other, which may minimize a frictional force occurring on the wheel 10. This configuration may be understood as a configuration in which the two rotation center axes Y1 and Y2 of the roller member 200 and the complementary member 300 adjacent to each other are disposed approximately in parallel.

In contrast, at least some of the complementary members 300 provided on the wheel 10 according to the second embodiment of the present disclosure may be configured to perform a reversible translational motion.

More specifically, with reference to FIGS. 4 to 6, the complementary member 300 provided on the wheel 10 according to the second embodiment of the present disclosure may further include a ball region 310 configured to be movable in the radial direction R of the wheel 10, and an accommodation region 320 fixedly coupled to the rim part 100 and configured to accommodate at least a part of the ball region 310. More specifically, the ball region 310 may be configured to perform a reversible translational motion, such that the ball region 310 may be moved to the accommodation region 320 when an external force is applied, and the ball region 310 may protrude outward again when the external force is eliminated. An elastic member (e.g., a spring) may be provided in the accommodation region 320 and press the ball region 310 outward to allow the ball region 310 to perform the above-mentioned motion. More particularly, as illustrated in FIGS. 4 to 6, according to the second embodiment of the present disclosure, at least a part of the ball region 310 may further protrude outward than the roller member 200 in the radial direction R of the wheel 10 in the state in which an external force is eliminated.

According to the first and second embodiments of the present disclosure, the magnitudes of the angles defined between the rotation axis X of the wheel 10 and the first rotation center axes Y1 of the plurality of roller members 200 provided on the wheel 10 may be substantially equal or correspond to one another. In this case, the magnitude of the angle defined between the roller member 200 and the rotation axis X and the direction, in which the roller member 200 is aligned, may be always constant in the state in which any one roller member 200, among the plurality of roller members 200, is in contact with the ground surface. Therefore, the wheel 10 may have the same traveling properties (e.g., the traveling direction of the wheel) regardless of whether any one roller member, among the plurality of roller members 200, comes into contact with the ground surface, which may ensure driving stability and ease of control.

With continued reference to FIGS. 1 to 6, in the wheel 10 according to the first and second embodiments of the present disclosure, a region, in which any one roller member 200, among the plurality of roller members 200, is rotatably coupled to the first side rim 110, may be spaced apart from a region, in which another roller member 200 is rotatably coupled to the second side rim 120, in one of the two circumferential direction A of the wheel 10. This configuration may be understood as a configuration in which when the wheel 10 is viewed from a position spaced apart from the wheel 10 in the direction in which the rotation axis X of the wheel 10 extends, a group of the regions, in which the plurality of roller members 200 is rotatably coupled to the second side rim 120, is placed at a position rotated by a predetermined angle about the rotation axis X of the wheel 10 from a group of the regions in which the plurality of roller members 200 is rotatably coupled to the first side rim 110. In the present disclosure, the circumferential direction A of the wheel 10 is defined as a direction that surrounds the rotation axis X of the wheel 10 in a perpendicular direction.

According to the first and second embodiments of the present disclosure, the number of roller members 200 provided on the wheel 10 may correspond to the number of complementary members 300. For example, the complementary members 300 may be provided to correspond to the roller members 200 in a one-to-one manner such that each complementary member 300 corresponds to one roller member 200.

In this case, the complementary member 300 may be provided to partially overlap the roller member 200 corresponding to the complementary member. More specifically, with reference to FIGS. 1 to 6, a part of the complementary member 300 may be provided to face the roller member 200 corresponding to the complementary member 300 in the circumferential direction A of the wheel 10, and another part of the complementary member 300 may be spaced apart from the roller member 200 corresponding to the complementary member 300 in the direction in which the rotation axis X extends. This configuration may be understood as a configuration in which a part of the complementary member 300 is positioned to be close to the inside of the wheel 10 than an outer end of the roller member 200 based on the direction of the rotation axis X, and another part of the complementary member 300 is positioned to be close to the outside of the wheel 10 than the outer end of the roller member 200 based on the direction of the rotation axis X.

In addition, according to the first and second embodiments of the present disclosure, the complementary member 300 may be provided to face a central region of the roller member 200 corresponding to the complementary member 300 in the direction in which the rotation axis X extends. This configuration may be understood as a configuration in which at least a part of the complementary member 300 is provided to overlap the central region of the roller member 200 in the circumferential direction A of the wheel 10. Meanwhile, the central region of the roller member 200 may refer to a central portion of the roller member 200 based on the direction in which the first rotation center axis Y1 of the roller member 200 extends.

According to the first and second embodiments of the present disclosure, the roller member 200 may include a shape having a diameter that decreases in a direction away from the central region of the roller member 200 based on the direction in which the first rotation center axis Y1 extends. More particularly, the entire portion of the roller member 200 may have a shape having a diameter that decreases in the direction away from the central region based on the direction in which the first rotation center axis Y1 extends. The entire portion of the roller member 200 may have a shape having a diameter that at least does not increase.

Although not explicitly illustrated in the drawings, according to the first and second embodiments of the present disclosure, a curved surface region may be formed on the roller member 200, and the curved surface region may be formed at the outer end of the wheel 10 based on the direction in which the rotation axis X of the wheel 10 extends. The curved surface region may have a curved shape protruding outward. The outer end of the roller member 200, which is determined based on the direction of the rotation axis X, may be a region of the roller member 200 that comes into contact with the ground surface or obstacle first in case that the wheel 10 moves in the direction parallel to the rotation axis X (i.e., the wheel 10 moves in the leftward/rightward direction without separate steering like a crab walk). Therefore, in case that the curved surface region is formed at the outer end of the roller member 200, it is possible to reduce or minimize an impact occurring when the roller member 200 comes into contact with the ground surface or obstacle during a process in which the wheel 10 moves in the direction parallel to the rotation axis X.

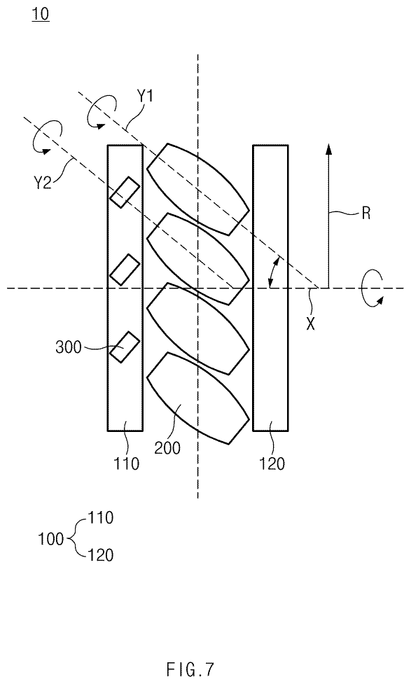

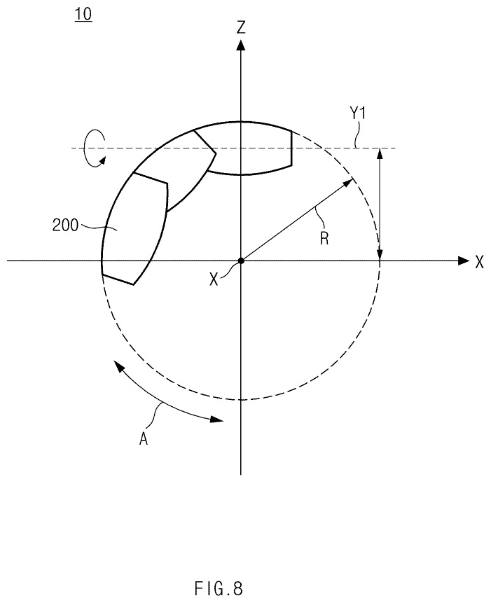

FIG. 7 is a view schematically illustrating a state in which the rotation axis of the wheel and the rotation center axis of the roller member define a predetermined angle, and the rotation axis of the wheel and the rotation center axis of the complementary member define a predetermined angle in the wheel according to the first embodiment of the present disclosure, and FIG. 8 is a view illustrating shapes of the roller members when the wheel according to the first embodiment of the present disclosure is viewed from a position spaced apart from the wheel in the direction in which the rotation axis extends.

In one embodiment, an outer surface of the wheel 10 in the radial direction R may have an approximately circular or cylindrical shape. Therefore, as illustrated in FIGS. 7 and 8, the outer surface of the roller member 200, which defines most of the outer surface of the wheel 10 based on the radial direction R, may include a part of the circular or cylindrical shape. More specifically, according to the present disclosure, when the roller member 200 is cut in a direction (an upward/downward direction based on FIG. 7) perpendicular to the direction in which the rotation axis X extends, an outer periphery of the roller member 200 based on the radial direction R of the wheel 10 may include a part of a circular shape having a center, i.e., the rotation axis X and having a radius i.e., a radius of the wheel 10 (see FIG. 8). More specifically, the cross-sectional shape of the roller member 200 may be applied all the plurality of roller members 200 provided on the wheel 10. Therefore, the cross-sectional shapes of the plurality of roller members 200 overlap one another, thereby defining most of the outer surface of the wheel 10 based on the radial direction R. However, the non-uniformity sections 10a (see FIGS. 3 and 6 and the like) may be formed in a part of the region in which the two adjacent roller members 200 overlap each other. According to the first and second embodiments of the present disclosure, the non-uniformity section may be filled with the complementary member 300 (see FIGS. 1 to 6). Meanwhile, the description of the wheel 10 according to the first embodiment of the present disclosure described with reference to FIGS. 7 and 8 may be equally applied to the second embodiment of the present disclosure.

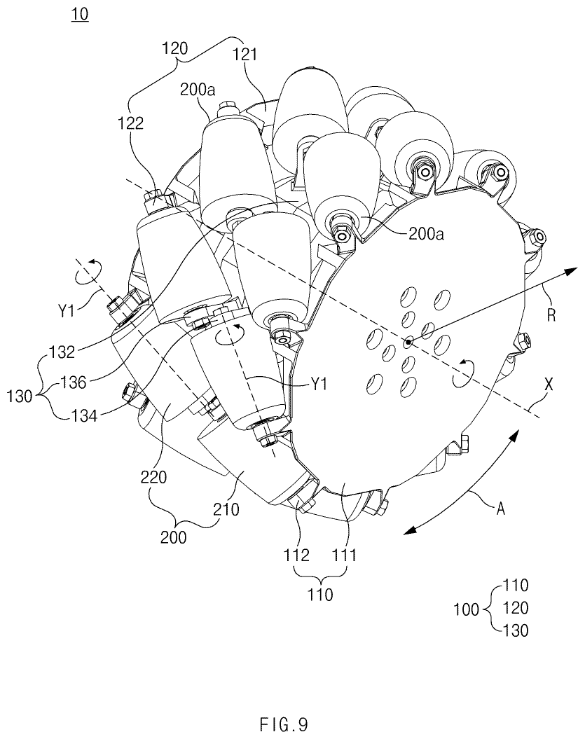

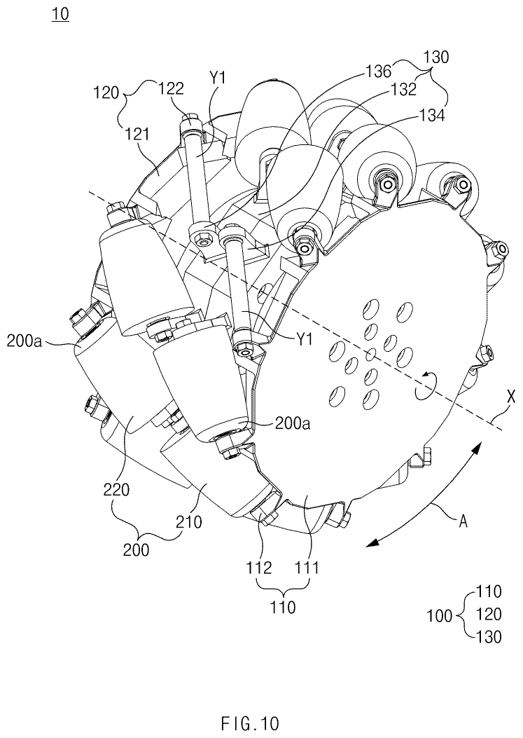

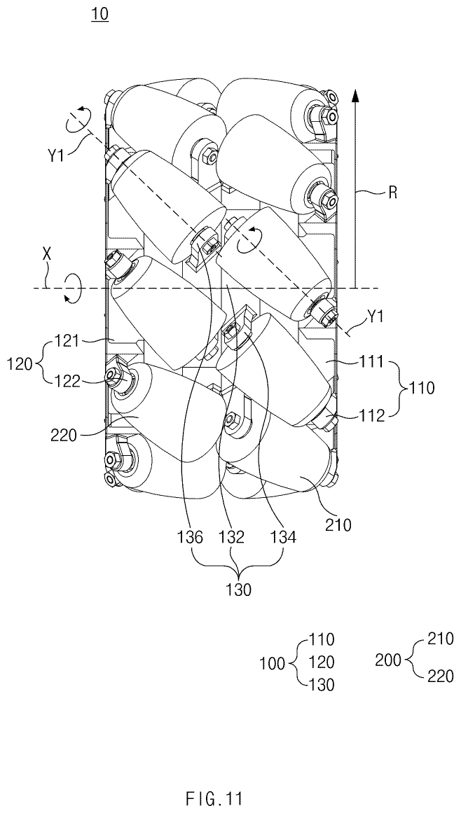

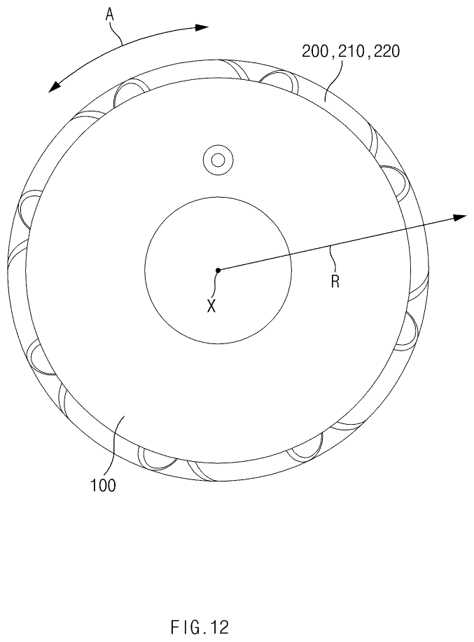

FIG. 9 is a perspective view of a wheel according to a third embodiment of the present disclosure, and FIG. 10 is a perspective view of the wheel according to the third embodiment of the present disclosure, i.e., a view illustrating a state in which some roller members are removed. FIG. 11 is a front view of the wheel according to the third embodiment of the present disclosure, and FIG. 12 is a side view according to the third embodiment of the present disclosure.

Similar to the wheels according to the first and second embodiments of the present disclosure, the wheel according to the third embodiment of the present disclosure may be a kind of mecanum wheel, i.e., a mecanum wheel having a novel shape different from that in the related art. However, as described below, some of the plurality of roller members and some of the remaining roller members provided on the wheel according to the third embodiment of the present disclosure may be provided to be spaced apart from one another in the direction in which the rotation axis of the wheel extends.

More specifically, with reference to FIGS. 9 to 12, the wheel 10 according to the third embodiment of the present disclosure may be a wheel including the rim part 100 configured to be rotatable about the rotation axis X. In addition, the wheel 10 may include the plurality of roller members 200 rotatably coupled to the rim part 100 and provided in the direction in which the plurality of roller members 200 surrounds the rotation axis X.

In this case, according to the third embodiment of the present disclosure, the plurality of roller members 200 may include first roller members and second roller members. More specifically, the plurality of roller members 200 may include a plurality of first roller members 210 provided in a direction in which the plurality of first roller members 210 surrounds the rotation axis X, and a plurality of second roller members 220 spaced apart from the plurality of first roller members 210 in the direction in which the rotation axis X extends. Similar to the first roller members 210, the second roller members 220 are provided in a direction in which the plurality of second roller members 220 surrounds the rotation axis X. In other words, the plurality of first roller members 210 and second roller members 220 are both arranged to surround the rotation axis X, while being spaced apart from each other along the direction of the rotation axis. With this arrangement, the plurality of first roller members 210 may be provided to be biased toward one side of the wheel 10 based on the direction in which the rotation axis X extends, and the plurality of second roller members 220 may be provided to be biased toward the other side of the wheel 10 based on the direction in which the rotation axis X extends.

In this case, according to the third embodiment of the present disclosure, the first roller members 210 and the second roller members 220 may be alternately disposed along the outer surface of the wheel 10 based on the radial direction R. More specifically, the first roller members 210 and the second roller members 220 may be alternately disposed one by one in the circumferential direction A of the wheel 10.

According to the third embodiment of the present disclosure, the wheel 10 may have the structure in which the plurality of roller members 200 disposed in the circumferential direction A is divided into two types of roller members provided at two opposite sides of the wheel 10 based on the extension direction of the rotation axis X. The roller members provided on the two opposite sides are alternately disposed in the circumferential direction A. In this case, the non-uniformity section formed in the outer surface of the wheel 10 based on the radial direction R may be reduced compare to when the roller members are not divided into the two types of roller members (i.e., roller members not arranged on two opposite sides of the wheel) and are instead disposed, as single roller members, in the circumferential direction of the wheel 10. In particular, the third embodiment of the present disclosure may have the technical feature capable of improving the uniformity of the outer surface of the wheel 10 without including the complementary member according to the first and second embodiments of the present disclosure.

Similar to the first and second embodiments of the present disclosure, in the wheel 10 according to the third embodiment of the present disclosure, the first rotation center axis Y1 of the roller member 200 with respect to the rim part 100 may have a predetermined angle with respect to the rotation axis X of the wheel 10. More specifically, the rotation center axis Y1 of the first roller member 210 and the rotation center axis Y1 of the second roller member 220 may each have a predetermined angle with respect to the rotation axis X of the wheel 10. For example, the rotation center axis Y1 of the first roller member 210 and the rotation center axis Y1 of the second roller member 220 may each have an angle of 40 degrees or more and 50 degrees or less (i.e., an angle in a range of 40 to 50 degrees) with respect to the rotation axis X of the wheel 10. Particularly, the rotation center axis Y1 of the first roller member 210 and the rotation center axis Y1 of the second roller member 220 may each have an angle of 45 degrees with respect to the rotation axis X of the wheel 10.

According to the third embodiment of the present disclosure, the rim part 100 provided on the wheel 10 may be divided into a plurality of regions. More specifically, the rim part 100 may include the first side rim 110 provided at one side of the roller member 200 based on the extension direction of the rotation axis X and configured such that one side of the first roller member 210 is rotatably coupled to the first side rim 110, the second side rim 120 provided at the other side of the roller member 200 based on the extension direction of the rotation axis X and configured such that one side of the second roller member 220 is rotatably coupled to the second side rim 120, and a central rim 130 provided between the first side rim 110 and the second side rim 120 in the extension direction of the rotation axis X and configured such that the other side of the first roller member 210 and the other side of the second roller member 220 are rotatably coupled to the central rim 130.

With reference to FIGS. 9 to 12, the first side rim 110 may include a first side rim body 111 configured to define a body of the first side rim, and a first side coupling region 112 protruding from the first side rim body 111 and configured such that one side of the first roller member 210 is rotatably coupled to the first side coupling region 112. The second side rim 120 may include a second side rim body 121 configured to define a body of the second side rim, and a second side coupling region 122 protruding from the second side rim body 121 and configured such that one side of the second roller member 220 is rotatably coupled to the second side coupling region 122. In addition, the central rim 130 may include a central rim body 132 configured to define a body of the central rim 130, a plurality of first central coupling regions 134 protruding from the central rim body 132 and configured such that the other side of the first roller member 210 is rotatably coupled to each of the plurality of first central coupling regions 134, and a plurality of second central coupling regions 136 protruding from the central rim body 132 and configured such that the other side of the second roller member 220 is rotatably coupled to each of the plurality of second central coupling regions 136. That is, according to the third embodiment of the present disclosure, the first central coupling region 134 and the second central coupling region 136 may be separately provided. In this case, the configuration in which two components are provided separately may be understood as a configuration in which the two components are connected indirectly to each other by means of the central rim body 132 without being connected directly to each other or in contact with each other. However, the first central coupling regions 134 and the second central coupling regions 136 may correspond to one another in a one-to-one manner. In this case, the second central coupling region 136, which corresponds to the first central coupling region 134, may mean the second central coupling region 136 provided to be closest to the first central coupling region 134 among the plurality of second central coupling regions 136.

In particular, according to the third embodiment of the present disclosure, the first central coupling region 134 and the second central coupling region 136, which is adjacent to the first central coupling region, may be provided separately. In this case, in case that one of the first and second central coupling regions 134 and 136 adjacent to each other is damaged and the first or second roller member 210 or 220 coupled to the damaged central coupling region 134 or 136 cannot exhibit the function thereof, the other roller member 210 or 220 may continuously exhibit the function thereof, which may improve the safety of the wheel 10.

With reference to FIGS. 9 to 12, the first central coupling region 134 and the second central coupling region 136, which is adjacent to the first central coupling region, may be at least partially spaced apart from each other in the direction in which the first rotation center axis Y1 of the roller member 200 extends relative to the rim part 100. Furthermore, the first central coupling region 134 and the second central coupling region 136, which is adjacent to the first central coupling region, may be at least partially spaced apart from each other even in a direction intersecting the direction in which the first rotation center axis Y1 of the roller member 200 extends relative to the rim part 100.

According to the third embodiment of the present disclosure, the magnitudes of the angles defined between the rotation axis X of the wheel 10 and the first rotation center axes Y1 of the plurality of roller members 200 provided on the wheel 10 may be substantially equal or correspond to one another. More specifically, the magnitudes of the angles defined between the rotation axis X of the wheel 10 and the rotation center axes Y1 of the plurality of first roller members 210 may be equal or correspond to one another, and the magnitudes of the angles defined between the rotation axis X of the wheel 10 and the rotation center axes Y1 of the second roller members 220 may be equal or correspond to one another. In addition, a magnitude of the angle defined between the rotation center axis Y1 of any one first roller member 210 and the rotation axis X of the wheel 10 and a magnitude of the angle defined between the rotation center axis Y1 of any one second roller member 220 and the rotation axis X of the wheel 10 may be substantially equal or correspond to each other.

As described above, the first central coupling region 134 and the second central coupling region 136, which is adjacent to the first central coupling region, may be at least partially spaced apart from each other in the direction intersecting the direction in which the rotation center axis Y1 of the roller member 200 extends relative to the rim part 100. Therefore, the rotation center axis Y1 of the first roller member 210, which is rotatably coupled to the first central coupling region 134, and the rotation center axis Y1 of the second roller member 220, which is rotatably coupled to the second central coupling region 136, may be spaced apart from each other in the direction intersecting the direction in which the rotation center axis Y1 extends.

With reference to FIGS. 9 to 12, according to the third embodiment of the present disclosure, the first roller member 210 or the second roller member 220 may include a section having a circular cross-section made by cutting the roller member in the direction perpendicular to the rotation center axis Y1 with respect to the rim part 100. More particularly, the first roller member 210 and the second roller member 220 may each have a section having a circular cross-section made by cutting the roller member in the direction perpendicular to the first rotation center axis Y1.

In this case, a size of the cross-section of the first roller member 210 or the second roller member 220 may decrease toward the outer end of the wheel 10. More specifically, the first roller member 210 or the second roller member 220 may include a section in which the size of the cross-section taken in the direction perpendicular to the first rotation center axis Y1 decreases toward the outer end of the wheel 10 in the direction in which the rotation axis X extends. More particularly, the first roller member 210 and the second roller member 220 may each have a section in which the size of the cross-section decreases or at least does not increase toward the outer end of the wheel 10 in the direction in which the rotation axis X extends.

According to the present disclosure, a curved surface region may be formed at the outer end of the roller member 200. More specifically, a curved surface region 200a may be formed on the first roller member 210 or the second roller member 220 and formed at the outer end of the wheel based on the direction in which the rotation axis X of the wheel 10 extends. The curved surface region 200a may have a curved shape protruding outward. More particularly, the curved surface regions 200a may be respectively formed on the first roller member 210 and the second roller member 220. The outer ends of the first roller member 210 and the second roller member 220 based on the direction of the rotation axis X may be regions of the first roller member 210 and the second roller member 220 that come into contact with the ground surface or obstacle first in case that the wheel 10 moves in the direction parallel to the rotation axis X (i.e., the wheel 10 moves in the leftward/rightward direction without separate steering like a crab walk). Therefore, in case that the curved surface regions 200a are formed at the outer end of the first roller member 210 and/or the outer end of the second roller member 220, it is possible to minimize an impact occurring when the roller member 200 comes into contact with the ground surface or obstacle during a process in which the wheel 10 moves in the direction parallel to the rotation axis X.

According to the third embodiment of the present disclosure, the rim part 100 provided on the wheel 10 may be disposed inward of the roller member 200 in the direction in which the rotation axis X extends. More specifically, although not illustrated directly in FIGS. 9 to 12, the outer end of the rim part 100 based on the direction in which the rotation axis X extends may be disposed to be closer to the inside based on the direction in which the rotation axis X extends than the outer end of the roller member 200 based on the direction in which the rotation axis X extends. More specifically, one outer end of the rim part 100 based on the direction in which the rotation axis X extends may be positioned inward of the outer end of the first roller member 210 based on the direction in which the rotation axis X extends, and the other outer end of the rim part 100 based on the direction in which the rotation axis X extends may be positioned inward of the outer end of the second roller member 220 based on the direction in which the rotation axis X extends. In this case, at least a part of the first side coupling region 112 may protrude outward from the outer surface of the first side rim body 111 in the direction in which the rotation axis X extends, and at least a part of the second side coupling region 122 may protrude outward from the outer surface of the second side rim body 121 in the direction in which the rotation axis X extends. According to the above-mentioned structure, the rim part 100 is avoided or prevented from interfering with the ground surface or obstacle during the process in which the wheel 10 moves in the direction in which the rotation axis X extends, such that the rim part 100 may be physically protected from the outside.

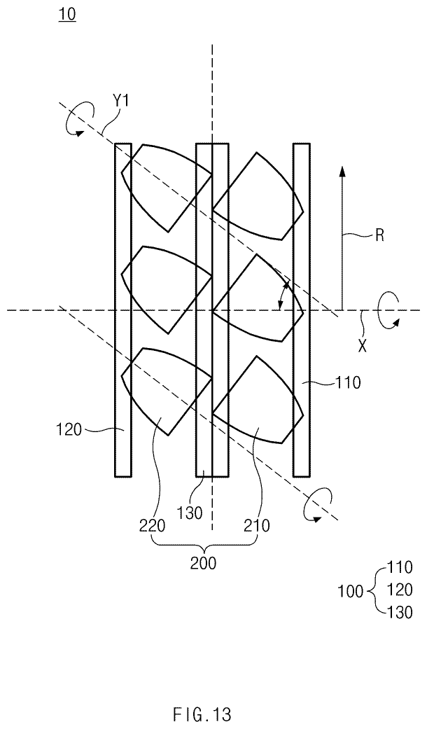

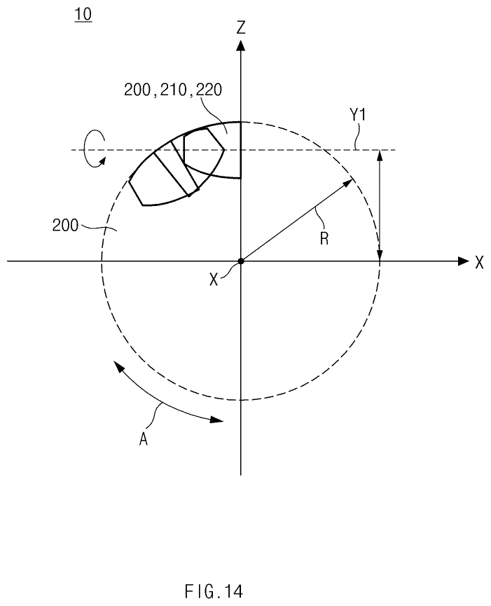

FIG. 13 is a view schematically illustrating a state in which the rotation axis of the wheel and the rotation center axis of the roller member define a predetermined angle, and the rotation axis of the wheel and the rotation center axis of the complementary member define a predetermined angle in the wheel according to the third embodiment of the present disclosure, and FIG. 14 is a view illustrating shapes of the roller members when the wheel according to the third embodiment of the present disclosure is viewed from a position spaced apart from the wheel in a direction in which the rotation axis extends.

Like the first and second embodiments of the present disclosure, the outer surface of the wheel 10 based on the radial direction R according to the third embodiment of the present disclosure may also have an approximately circular or cylindrical shape. Therefore, as illustrated in FIGS. 13 and 14, according to the third embodiment of the present disclosure, the outer surface of the roller member 200, which defines most of the outer surface of the wheel 10 based on the radial direction R, may include a part of the circular or cylindrical shape. More specifically, according to the third embodiment of the present disclosure, when the roller member 200 is cut in a direction (an upward/downward direction based on FIG. 13) perpendicular to the direction in which the rotation axis X extends, outer peripheries of the first roller member 210 and the second roller member 220 based on the radial direction R of the wheel 10 may each include a part of a circular shape having the rotation axis X as a center and a radius as a radius of the wheel 10 (see FIG. 14). More specifically, the cross-sectional shapes of the first roller member 210 and the second roller member 220 may be applied to all the plurality of first roller members 210 and the plurality of second roller members 220 provided on the wheel 10. Therefore, the cross-sectional shapes of the first roller member 210 and the second roller member 220 overlap one another, thereby defining the outer surface of the wheel 10 based on the radial direction R.

With reference to FIGS. 9 to 15, an assembly (hereinafter, referred to as a ‘first assembly’) made by coupling the first side rim 110 and the first roller member 210 and an assembly (hereinafter, referred to as a ‘second assembly’) made by coupling the second side rim 120 and the second roller member 220 may be separately manufactured and then coupled to each other. For example, a first concave-convex structure may be formed on one side surface of the first assembly based on the width direction of the first side rim 110, a second concave-convex structure, which corresponds in shape to the first concave-convex structure, may be formed on one side surface of the second assembly based on the width direction of the second side rim 120, and the wheel 10 according to the present disclosure may be manufactured by assembling the first assembly and the second assembly by coupling the first concave-convex structure and the second concave-convex structure.

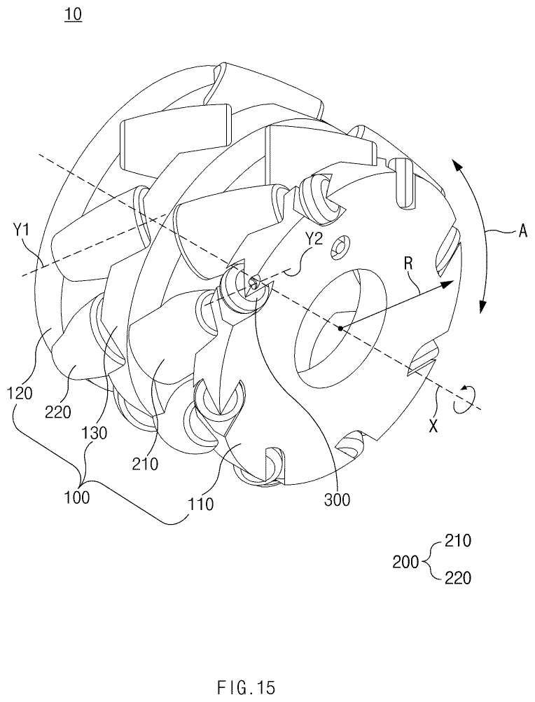

FIG. 15 is a perspective view of a wheel according to a fourth embodiment of the present disclosure.

According to the fourth embodiment of the present disclosure, the wheel 10 may have a structure further including the complementary members 300 added to the wheel according to the third embodiment of the present disclosure. Hereinafter, the fourth embodiment of the present disclosure is described in detail with reference to the configurations that differ from those defined in the third embodiment of the present disclosure. Hereinafter, the description of the wheel according to the fourth embodiment of the present disclosure, except for the above-mentioned configurations, may be replaced with the description of the wheel according to the third embodiment of the present disclosure.

More specifically, with reference to FIG. 15, the wheel 10 according to the fourth embodiment of the present disclosure may further include the plurality of complementary members 300 coupled to the rim part 100 and disposed in the direction in which the plurality of complementary members 300 surrounds the rotation axis X. In this case, according to the fourth embodiment of the present disclosure, when the wheel 10 is viewed from a position spaced apart from the wheel 10 in the direction in which the rotation axis X extends, non-uniformity sections having shapes recessed inward in the radial direction R of the wheel 10 may be formed in the outer surface of the wheel 10 based on the radial direction R. The non-uniformity section according to the fourth embodiment of the present disclosure may correspond to the non-uniformity section 10a provided in the wheel 10 according to the first and second embodiments of the present disclosure described above with reference to FIGS. 1 to 6.

In this case, according to the fourth embodiment of the present disclosure, the complementary member 300 may be provided to overlap the non-uniformity section. More specifically, the rim part 100 may include the first side rim 110 provided at one side of the roller member 200 based on the extension direction of the rotation axis X and configured such that one side of the first roller member 210 is rotatably coupled to the first side rim 110, and the second side rim 120 provided at the other side of the roller member 200 based on the extension direction of the rotation axis X and configured such that one side of the second roller member 220 is rotatably coupled to the second side rim 120. Further, the complementary members 300 may be provided on one of or both the first side rim 110 and the second side rim 120. In one embodiment, the complementary members 300 may be provided only on either the first side rim 110 or the second side rim 120. For example, FIG. 15 illustrates a state in which the complementary members 300 are provided only on the first side rim 110.

FIG. 15 illustrates that the complementary members 300 are coupled to the rim part 100 so as to be rotatable about the second rotation center axis Y2. However, unlike the configuration illustrated in FIG. 15, the complementary member 300 may include an accommodation region fixed to the rim part 100, and a ball region at least partially accommodated in the accommodation region and configured to be movable in the radial direction R of the wheel 10.

The present disclosure has been described with reference to the limited embodiments and the drawings, but the present disclosure is not limited thereby. The present disclosure may be carried out in various forms by those having ordinary skill in the art, to which the present disclosure pertains, within the technical spirit of the present disclosure and the scope equivalent to the appended claims.

What is claimed is:

1. A wheel having a rim part provided to be rotatable about a rotation axis of the wheel, the wheel comprising:
a plurality of roller members rotatably coupled to the rim part and arranged to surround the rotation axis,
wherein the plurality of roller members comprises:
a plurality of first roller members arranged to surround the rotation axis; and
a plurality of second roller members spaced apart from the plurality of first roller members in a direction in which the rotation axis extends, the plurality of second roller members being arranged to surround the rotation axis, and
wherein first roller members of the plurality of first roller members and second roller members of the plurality of second roller members are alternately disposed in a circumferential direction of the wheel.

2. The wheel of claim 1, wherein an outer end of the rim part based on the direction in which the rotation axis extends is positioned to be closer to an inside based on the direction in which the rotation axis extends than an outer end of the plurality of roller members based on the direction in which the rotation axis extends.

3. The wheel of claim 1, wherein a rotation center axis of the roller members with respect to the rim part has a predetermined angle with respect to the rotation axis.

4. The wheel of claim 2, wherein a rotation center axis of the plurality of roller members has an angle in a range of 40 degrees to 50 degrees with respect to the rotation axis.

5. The wheel of claim 1, wherein the rim part comprises:
a first side rim provided at a first side of the plurality of roller members based on an extension direction of the rotation axis and configured such that a first side of the first roller members is rotatably coupled to the first side rim;
a second side rim provided at a second side of the plurality of roller members based on the extension direction of the rotation axis and configured such that a first side of the second roller members is rotatably coupled to the second side rim; and
a central rim provided between the first side rim and the second side rim based on the extension direction of the rotation axis and configured such that a second side of the first roller members and a second side of the second roller members are rotatably coupled to the central rim, and
wherein the central rim comprises:
a central rim body configured to define a body of the central rim;
a first central coupling region protruding from the central rim body and configured such that the second side of the first roller members is rotatably coupled to the first central coupling region; and
a second central coupling region protruding from the central rim body and configured such that the second side of the second roller members is rotatably coupled to the second central coupling region.

6. The wheel of claim 5, wherein the first central coupling region and the second central coupling region, which is provided adjacent to the first central coupling region, are provided separately.

7. The wheel of claim 6, wherein the first central coupling region and the second central coupling region are at least partially spaced apart from each other in a direction in which a rotation center axis of the plurality of roller members extends relative to the rim part.

8. The wheel of claim 6, wherein the first central coupling region and the second central coupling region are at least partially spaced apart from each other in a direction intersecting a direction in which a rotation center axis of the plurality of roller members extends relative to the rim part.

9. The wheel of claim 1, wherein magnitudes of angles defined between rotation center axes of the plurality of roller members and the rotation axis correspond to one another.

10. The wheel of claim 8, wherein the rotation center axes of the first roller members with respect to the rim part and the rotation center axes of the second roller members with respect to the rim part are spaced apart from one another in a direction intersecting the direction in which the rotation center axis extends.

11. The wheel of claim 1, wherein a curved surface region is formed on the first roller members or the second roller members at an outer end of the wheel based on the direction in which the rotation axis extends, and the curved surface region has a curved shape protruding outward.

12. The wheel of claim 1, wherein the first roller members or the second roller members include a section having a circular cross-section taken in a direction perpendicular to a rotation center axis of the plurality of roller members with respect to the rim part.

13. The wheel of claim 1, wherein the first roller members or the second roller members include a section in which a size of a cross-section taken in a direction perpendicular to a rotation center axis of the plurality of roller members with respect to the rim part decreases toward an outer end of the wheel based on the direction in which the rotation axis extends.

14. The wheel of claim 1, wherein when the first roller members and the second roller members are cut in a direction perpendicular to the direction in which the rotation axis extends, outer peripheries of the first roller members and the second roller members based on a radial direction of the wheel each include a part of a circular shape having the rotation axis as a center and a radius as a radius of the wheel.

15. The wheel of claim 1, further comprising:
a plurality of complementary members coupled to the rim part and provided in a direction in which the plurality of complementary members surrounds the rotation axis,
wherein when the wheel is viewed from a position spaced apart from the wheel in the direction in which the rotation axis extends, a non-uniformity section having a shape recessed inward in a radial direction of the wheel is formed in the wheel, and
wherein the plurality of complementary members is provided to overlap the non-uniformity section.

16. The wheel of claim 15, wherein the rim part further comprises:
a first side rim provided on a first side of the plurality of roller members based on an extension direction of the rotation axis and configured such that a first side of the first roller members is rotatably coupled to the first side rim; and
a second side rim provided on a second side of the plurality of roller members based on the extension direction of the rotation axis and configured such that a first side of the second roller members is rotatably coupled to the second side rim, and
wherein the plurality of complementary members is provided on at least one of the first side rim or the second side rim.

17. The wheel of claim 16, wherein the plurality of complementary members is provided only on either the first side rim or the second side rim.
